(19) United States
(12) Patent Application Publication
(10) Pub. No.: US 2025/0388076 A1
(43) Pub. Date: Dec. 25, 2025

(54) VEHICLE COOLING AIR DISCHARGE STRUCTURE

(71) Applicant: SUBARU CORPORATION, Tokyo (JP)

(72) Inventor: Satoshi SHIMIZU, Tokyo (JP)

(73) Assignee: SUBARU CORPORATION, Tokyo (JP)

(21) Appl. No.: 19/246,032

(22) Filed: Jun. 23, 2025

(30) Foreign Application Priority Data
Jun. 24, 2024 (JP) 2024-101288

(51) Int. Cl. B60K 11/08; B62D 35/02

(52) U.S. Cl. CPC B60K 11/08; B62D 35/02

(57) ABSTRACT

Provided is a vehicle cooling air discharge structure that discharges cooling air blown into an underfloor space of a vehicle body of a vehicle to the outside of the vehicle. The vehicle cooling air discharge structure includes an undercover that covers the underfloor space from below the vehicle body. The undercover has, behind a front wheel tire house of the vehicle body, a first vehicle-exterior communication portion through which the cooling air is discharged to the outside of the vehicle. At least a cooling water pipe of the vehicle or a heat generating component of the vehicle is disposed on an upper surface of the undercover, in the underfloor space, around the first vehicle-exterior communication portion.

### CROSS-REFERENCE TO RELATED APPLICATIONS

The present application claims priority from Japanese Patent Application No. 2024-101288 filed on Jun. 24, 2024, the entire contents of which are hereby incorporated by reference.

### BACKGROUND OF THE INVENTION

### Field of the Invention

The disclosure relates to a vehicle cooling air discharge structure.

### Description of Background Art

Japanese Unexamined Patent Application Publication No. 2012-136062 describes a vehicle cooling air discharge structure. The entire contents of this publication are incorporated herein by reference.

### SUMMARY OF THE INVENTION

According to one aspect of the present invention, a vehicle cooling air discharge structure includes a vehicle body including a front wheel tire house and an undercover that covers an underfloor space of a vehicle such that the undercover has a vehicle-exterior communication portion formed behind the front wheel tire house and that cooling air blown into an underfloor space of the vehicle body is discharged to an outside of the vehicle through the vehicle-exterior communication portion. The vehicle-exterior communication portion of the undercover is formed at a position such that at least one of a cooling water pipe and a heat generating component disposed on an upper surface of the undercover is positioned around the vehicle-exterior communication portion in the underfloor space.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A is a perspective view illustrating a vehicle having a vehicle cooling air discharge structure according to an embodiment of the disclosure;

FIG. 1B is a perspective view illustrating the vehicle having the vehicle cooling air discharge structure according to the embodiment of the disclosure;

FIG. 2 is a cross-sectional view illustrating the vehicle having the vehicle cooling air discharge structure according to the embodiment of the disclosure;

FIG. 3 is a plan view illustrating the vehicle cooling air discharge structure according to the embodiment of the disclosure; and

FIG. 4 is a sectional view illustrating the vehicle cooling air discharge structure according to the embodiment of the disclosure.

### DETAILED DESCRIPTION OF THE EMBODIMENTS

Embodiments will now be described with reference to the accompanying drawings, wherein like reference numerals designate corresponding or identical elements throughout the various drawings.

Hereinafter, a vehicle cooling air discharge structure 10 according to an embodiment of the disclosure will be described in detail with reference to the drawings. The front-rear direction in the drawings indicates the overall length direction of a vehicle 11, the left-right direction in the drawings indicates the vehicle width direction of the vehicle 11, and the top-bottom direction in the drawings indicates the height direction of the vehicle 11.

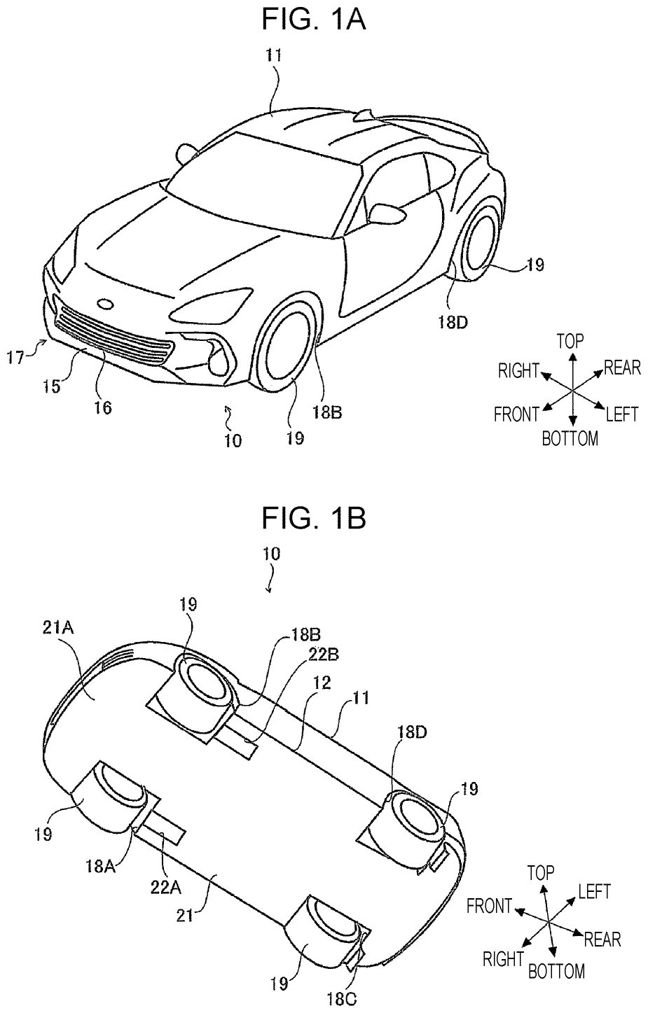

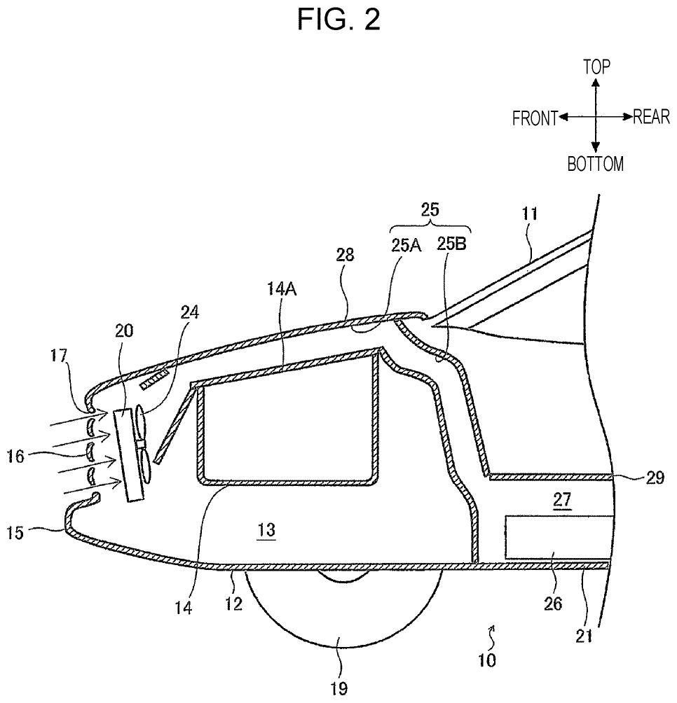

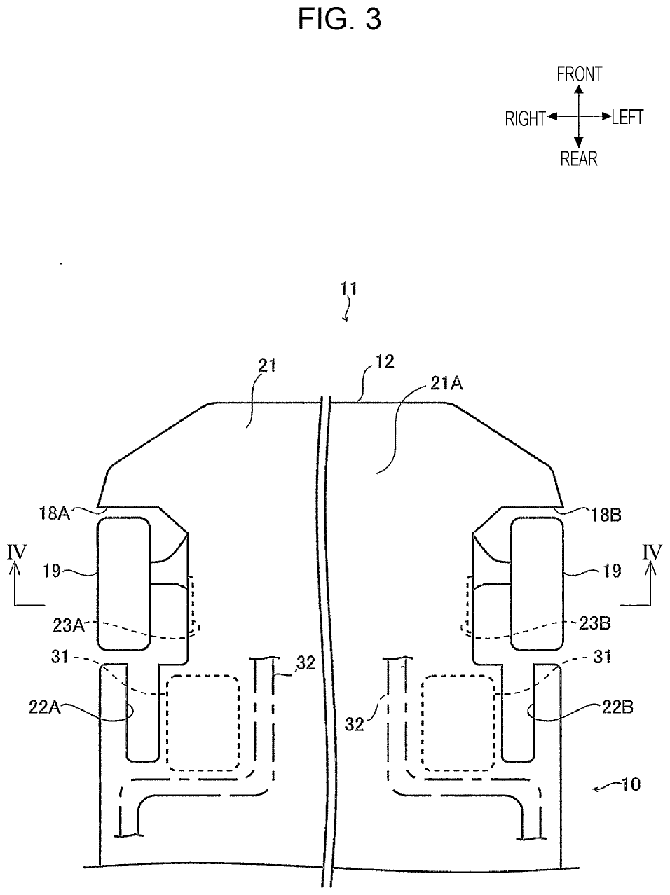

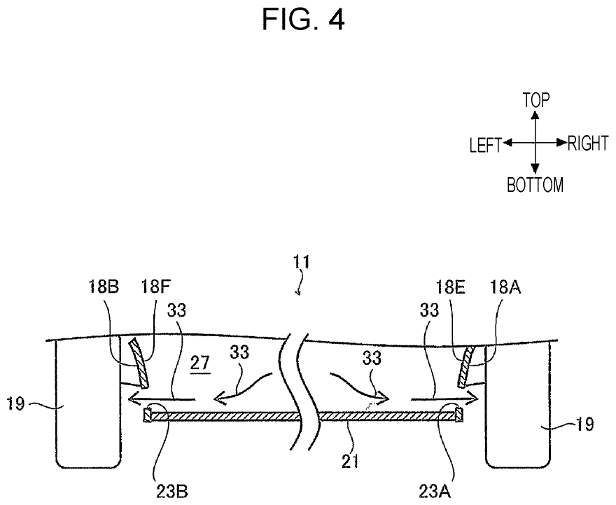

FIG. 1A is a perspective view illustrating the vehicle 11 having the vehicle cooling air discharge structure 10 of the present embodiment, and illustrates a state in which the vehicle 11 is viewed from above. FIG. 1B is a perspective view illustrating the vehicle 11 having the vehicle cooling air discharge structure 10 of the present embodiment, and illustrates a state in which the vehicle 11 is viewed from below. FIG. 2 is a cross-sectional view illustrating the vehicle 11 having the vehicle cooling air discharge structure 10 of the present embodiment. FIG. 3 is a plan view illustrating regions where heat generating components are disposed in the vehicle cooling air discharge structure 10 of the present embodiment. FIG. 4 is a cross-sectional view illustrating the flows of cooling air discharged from the vehicle cooling air discharge structure 10 of the present embodiment to the outside of the vehicle, and illustrates a cross-section taken along line IV-IV in FIG. 3.

As illustrated in FIG. 1A, the vehicle 11 is, for example, an engine vehicle, a battery electric vehicle (BEV), a hybrid electric vehicle (HEV), a plug-in hybrid electric vehicle (PHEV), or the like.

In the case where the vehicle 11 is, for example, a BEV, the engine components are not used. Thus, a compartment 13 (see FIG. 2) at the front portion of the vehicle body 12 can be used as, for example, a front trunk 14 (see FIG. 2). The front trunk 14 is mainly a storage space for storing luggage.

As illustrated, a front bumper 15, a front grille 16, and a cooling air inlet 17 are formed in the front portion of the vehicle body 12. The cooling air inlet 17 is, for example, an opening for introducing traveling air into the compartment 13 when the vehicle 11 is traveling. The front grille 16 is disposed above the front bumper 15 and is assembled to a region of the vehicle body 12 where the cooling air inlet 17 is formed.

As illustrated in FIG. 1B, front wheel tire houses 18A and 18B and rear wheel tire houses 18C and 18D are assembled to four corners of the vehicle body 12. Tires 19 are assembled in the front wheel tire houses 18A and 18B and the rear wheel tire houses 18C and 18D.

As illustrated, an undercover 21 is attached to a bottom surface of the vehicle body 12 in consideration of aerodynamic characteristics of the vehicle 11. The undercover 21 is formed of, for example, a steel plate, carbon fiber reinforced plastic (CFRP), or the like. In the present embodiment, for example, the undercover 21 is disposed over substantially the overall surface from the front portion to the rear portion of the vehicle body 12 except for the regions where the front wheel tire houses 18A and 18B and the rear wheel tire houses 18C and 18D are disposed. The undercover 21 may be disposed, for example, from the front portion of the vehicle body 12 to the vicinity of the leading ends of the rear wheel tire houses 18C and 18D, and any design change is possible.

Further, first vehicle-exterior communication portions 22A and 22B are formed in the undercover 21, behind the front wheel tire houses 18A and 18B, respectively. The first vehicle-exterior communication portions 22A and 22B are formed as openings that allow an underfloor space 27 (see FIG. 2) of the vehicle body 12 and the outside of the vehicle to communicate with each other. As illustrated, the first vehicle-exterior communication portions 22A and 22B may be formed in a cutout shape continuous with the front wheel tire houses 18A and 18B.

Here, a front region 21A of the undercover 21 is a region from the front portion of the vehicle body 12 to the vicinity of the leading ends of the front wheel tire houses 18A and 18B. The front region 21A of the undercover 21 has a slope shape that is curved so as to be convex vertically downward of the vehicle body 12 from the front to the rear of the vehicle body 12.

With this structure, the traveling air generated by traveling of the vehicle 11 flows to the lower side of the vehicle body 12 along the front region 21A of the undercover 21, and is contracted to increase its flow speed. The main flow of the traveling air flows from the front to the rear of the vehicle body 12 between the front wheel tire houses 18A and 18B. As a result, the lower surface of the undercover 21 between the front wheel tire houses 18A and 18B enters a negative pressure state, generating a vertically downward load in the vehicle body 12. Thus, the CI value of the vehicle 11 improves.

As described above, in the present embodiment, the first vehicle-exterior communication portions 22A and 22B are formed in the undercover 21, behind the front wheel tire houses 18A and 18B. With this structure, a negative pressure is generated below the first vehicle-exterior communication portions 22A and 22B, so that the cooling air blown into the underfloor space 27 is sucked out of the vehicle. As a result, during traveling of the vehicle 11, the amount of traveling air introduced from the cooling air inlet 17 into the compartment 13 also increases, and the amount of air that passes through a radiator 20 (see FIG. 2) also increases. Thus, the function of cooling an in-vehicle battery 26 (see FIG. 2) and the like of the vehicle 11 is improved.

As will be described in detail later with reference to FIG. 4, second vehicle-exterior communication portions 23A and 23B are formed in inner surfaces 18E and 18F of the front wheel tire houses 18A and 18B, beside the inner sides of the tires 19, respectively. The second vehicle-exterior communication portions 23A and 23B are formed as openings that allow the underfloor space 27 (see FIG. 2) of the vehicle body 12 and the outside of the vehicle, in other words, the underfloor space 27 and the spaces in the front wheel tire houses 18A and 18B, to communicate with each other. Further, the second vehicle-exterior communication portions 23A and 23B are formed further toward the front side of the vehicle body 12 and further toward the central side of the vehicle body 12 in the vehicle width direction than the first vehicle-exterior communication portions 22A and 22B.

As illustrated in FIG. 2, a front hood 28 that openably closes the upper opening of the compartment 13 is assembled to the front portion of the vehicle body 12, above the compartment 13 of the vehicle body 12. In the compartment 13 of the vehicle body 12, the radiator 20 and a blower fan 24 are disposed behind the cooling air inlet 17. The cooling air introduced from the cooling air inlet 17 into the compartment 13 passes through the radiator 20 and the blower fan 24, and is then blown to a cooling-air introduction air passage 25.

The blower fan 24 is disposed in the vicinity of the radiator 20, and operates when the vehicle 11 is stopped or when the vehicle 11 is traveling at a low speed to introduce air from outside the vehicle through the cooling air inlet 17 into the compartment 13. The cooling air in the present embodiment is air introduced from the outside to the inside of the vehicle 11. For example, the cooling air is traveling air introduced from the cooling air inlet 17 to the inside of the compartment 13 while the vehicle 11 is traveling, or suction air sucked from the cooling air inlet 17 to the inside of the compartment 13 by the operation of the blower fan 24 while the vehicle 11 is stopped.

The cooling-air introduction air passage 25 is an air passage for sending the cooling air introduced from the cooling air inlet 17 to the underfloor space 27 below a floor panel 29 of the vehicle body 12. For example, in the present embodiment, the cooling-air introduction air passage 25 includes a first air passage 25A between the front hood 28 and an opening/closing cover portion 14A of the front trunk 14, and a second air passage 25B that is located behind the front trunk 14 and communicates the underfloor space 27 with the first air passage 25A.

As illustrated, the underfloor space 27 is located below the cabin of the vehicle 11 and is formed as a space between the floor panel 29 of the vehicle body 12 and the undercover 21. A drive motor of the vehicle 11, the in-vehicle battery 26, and the like are accommodated in the underfloor space 27. As the in-vehicle battery 26, for example, a secondary battery such as a nickel hydrogen battery or a lithium ion battery, an all-solid-state battery, or the like is used.

A battery control unit (BCU), a junction box, an inverter, and the like are also disposed in the underfloor space 27, and these electronic devices are electrically coupled to the in-vehicle battery 26. Further, an electricity supply unit (ESU) or the like may be disposed in the underfloor space 27.

In the vehicle cooling air discharge structure 10 of the present embodiment, as illustrated as regions surrounded by dotted lines 31 in FIG. 3, the BCU, the junction box, the inverter, the ESU, and the drive motor, which are heat generating components, are disposed on the upper surface of the undercover 21, around the first vehicle-exterior communication portions 22A and 22B. These heat generating components are used as heat sources. With this structure, the regions where the first vehicle-exterior communication portions 22A and 22B are formed and the undercover 21 around the regions are warmed by heat that is generated from the heat generating components. It is less likely that when the vehicle 11 travels on a snowy road, water, snow, or the like splashed from the road surface adheres to the undercover 21 and freezes, and that the first vehicle-exterior communication portions 22A and 22B are blocked by the frozen body such as snow.

Further, the alternate long and short dash lines in FIG. 3 indicate regions where cooling water pipes 32, which communicate with the radiator 20 and through which the cooling water circulates, are disposed. The cooling water pipes 32 are disposed around the in-vehicle battery 26 in the underfloor space 27 and are also disposed on the upper surface of the undercover 21, around the first vehicle-exterior communication portions 22A and 22B. With this structure, the cooling water in the cooling water pipes 32 is heated by heat exchange with the in-vehicle battery 26 and the like, and thus, the undercover 21 around the first vehicle-exterior communication portions 22A and 22B can be heated. As a result, the first vehicle-exterior communication portions 22A and 22B are less likely to be blocked by the frozen body.

As described above, the second vehicle-exterior communication portions 23A and 23B are formed in the inner surfaces 18E and 18F of the front wheel tire houses 18A and 18B, beside the inner sides of the tires 19, respectively. Further, even when the vehicle 11 travels on a snowy road, unlike the first vehicle-exterior communication portions 22A and 22B, water, snow, or the like splashed from the road surface is less likely to be splashed toward the second vehicle-exterior communication portions 23A and 23B. As a result, the second vehicle-exterior communication portions 23A and 23B are less likely to be blocked by the frozen body.

With this structure, even when the first vehicle-exterior communication portions 22A and 22B are blocked by the frozen body, the cooling air in the underfloor space 27 is discharged from the second vehicle-exterior communication portions 23A and 23B to the outside of the vehicle. In other words, as indicated by arrows 33, the cooling air is sucked from the underfloor space 27 into the front wheel tire houses 18A and 18B, which are in a negative pressure state due to the traveling of the vehicle 11, via the second vehicle-exterior communication portions 23A and 23B.

Thereafter, in the front wheel tire houses 18A and 18B, as a result of the pressure behind the tires 19 being relatively negative due to the rotation of the tires 19, the cooling air is blown out to the rear of the front wheel tire houses 18A and 18B. As a result, the cooling air is blown at the frozen body that closes the first vehicle-exterior communication portions 22A and 22B and the undercover 21 therearound. Then, the cooling air exchanges heat with the in-vehicle battery 26 and the like in the underfloor space 27 to become warmer than the outside air temperature, thereby melting the frozen body and opening the first vehicle-exterior communication portions 22A and 22B.

In addition, as described above, during the traveling of the vehicle 11, in the front wheel tire houses 18A and 18B, the rear side of the tires 19 enters a relatively negative pressure state due to the influence of the rotation of the tires 19. The first vehicle-exterior communication portions 22A and 22B are formed closer to the rear ends of the front wheel tire houses 18A and 18B than the second vehicle-exterior communication portions 23A and 23B.

With this structure, when the first vehicle-exterior communication portions 22A and 22B are open, most of the cooling air in the underfloor space 27 is sucked out of the vehicle through the first vehicle-exterior communication portions 22A and 22B. Because the cooling air discharged from the underfloor space 27 is less likely to flow together with the main flow of the traveling air flowing below the undercover 21 during traveling of the vehicle 11, deterioration of the Cd value of the vehicle 11 is prevented.

In the present embodiment, the case where the steel material or the like is used as the material of the undercover 21 has been described, but the disclosure is not limited to this case. For example, a material having excellent thermal conductivity such as an aluminum alloy may be used as the material of the undercover 21. In this case, heat that is generated from the heat generating components in the vehicle 11 is efficiently transferred to the first vehicle-exterior communication portions 22A and 22B and the peripheral regions thereof. In addition, the first vehicle-exterior communication portions 22A and 22B are less likely to be blocked by the frozen body. In addition, various modifications can be made without departing from the scope of the disclosure.

A vehicle cooling air discharge structure according to an embodiment of the disclosure includes an undercover that covers an underfloor space of a vehicle body of a vehicle from below, and first vehicle-exterior communication portions are formed in the undercover, behind front wheel tire houses. Heat generating components of the vehicle are disposed on the upper surface of the undercover, around the first vehicle-exterior communication portions in the underfloor space. With this structure, when the vehicle travels on a snowy road, water, snow, and the like splashed from the road surface are less likely to adhere to the undercover and freeze. Since the first vehicle-exterior communication portions are less likely to be blocked by a frozen body such as snow, the cooling air in the underfloor space is stably discharged from the first vehicle-exterior communication portions to the outside of the vehicle.

For example, Japanese Unexamined Patent Application Publication No. 2012-136062 describes a vehicle cooling air discharge structure. In a vehicle, an engine room is formed in a front portion of the vehicle, and a cabin is formed behind the engine room. The lower portion of the engine room is covered with an undercover.

The undercover is, for example, a press-formed product of a steel plate, and the undercover is fastened and fixed to a suspension cross member. A rear side of the undercover is disposed to face a floor panel of the cabin, and an air passage for cooling air is formed between the undercover and the floor panel. When the vehicle travels forward, traveling air is introduced into the engine room from the front portion of the vehicle body and is used as cooling air.

Further, the rear end edges of the undercover on the left and right sides in the vehicle width direction of the vehicle are formed so as to protrude toward the rear side of the vehicle with respect to the central rear end edge. In other words, the central rear end edge of the undercover is formed so as to be cut toward the front side of the vehicle.

An aspect of the disclosure provides a vehicle cooling air discharge structure that discharges cooling air blown into an underfloor space of a vehicle body of a vehicle to the outside of the vehicle. The vehicle cooling air discharge structure includes an undercover that covers the underfloor space from below the vehicle body. The undercover has, behind a front wheel tire house of the vehicle body, a first vehicle-exterior communication portion through which the cooling air is discharged to the outside of the vehicle. At least a cooling water pipe of the vehicle or a heat generating component of the vehicle is disposed on an upper surface of the undercover, in the underfloor space, around the first vehicle-exterior communication portion.

In the conventional vehicle cooling air discharge structure, the rear end edges on the left and right sides of the undercover protrude further than the central rear end edge of the undercover, so that the cooling air introduced into the vehicle is actively discharged to the rear of the wheel houses for the front wheels.

However, when the vehicle travels on a snowy road, the discharge regions on the rear side of the wheel houses for the front wheels may be blocked by a frozen body produced by water, snow, or the like splashed from the road surface.

Furthermore, as a result of the discharge regions being closed, the cooling air is discharged to the outside from the discharge region at the central rear end edge of the undercover. Thus, the negative pressure effect is weakened in the mainstream portion of the traveling air flowing below the undercover. As a result, there is a problem in that the traveling air acts in a direction of lifting up the front side of the vehicle, and the ride comfort of the occupant deteriorates.

In addition, in an electric vehicle such as a battery electrical vehicle (BEV), exhaust system components included in an engine vehicle are omitted or downsized, and thus it is difficult to ensure the amount of heat for preventing freezing. As a result, there is a problem in that the water and snow freeze in the discharge region of the cooling air, making it difficult to maintain the aerodynamic characteristics of the vehicle.

It is desirable to provide a vehicle cooling air discharge structure that stably discharges cooling air introduced into the vehicle to the outside of the vehicle from a vehicle-exterior communication portion in the undercover.

Obviously, numerous modifications and variations of the present invention are possible in light of the above teachings. It is therefore to be understood that within the scope of the appended claims, the invention may be practiced otherwise than as specifically described herein.

1. A vehicle cooling air discharge structure, comprising:
a vehicle body comprising a front wheel tire house and an undercover configured to cover an underfloor space of a vehicle such that the undercover has a vehicle-exterior communication portion formed behind the front wheel tire house and that cooling air blown into an underfloor space of the vehicle body is discharged to an outside of the vehicle through the vehicle-exterior communication portion,
wherein the vehicle-exterior communication portion of the undercover is formed at a position such that at least one of a cooling water pipe and a heat generating component disposed on an upper surface of the undercover is positioned around the vehicle-exterior communication portion in the underfloor space.

2. The vehicle cooling air discharge structure according to claim 1, wherein the front wheel tire house has a second vehicle-exterior communication portion formed in front of the vehicle-exterior communication portion such that the cooling air is discharged to the outside of the vehicle through the second vehicle-exterior communication portion.

3. The vehicle cooling air discharge structure according to claim 2, wherein the second vehicle-exterior communication portion is formed beside an inner side of a tire of the vehicle body such that the cooling air discharged from the second vehicle-exterior communication portion passes through the vehicle-exterior communication portion via an interior of the front wheel tire house.

4. The vehicle cooling air discharge structure according to claim 1, wherein the vehicle body has a cooling air inlet formed in a front portion of the vehicle body and configured to introduce the cooling air into a compartment in the vehicle body such that the cooling air is blown into the underfloor space after being introduced into the compartment in the vehicle body from the cooling air inlet.

5. The vehicle cooling air discharge structure according to claim 2, wherein the vehicle body has a cooling air inlet formed in a front portion of the vehicle body and configured to introduce the cooling air into a compartment in the vehicle body such that the cooling air is blown into the underfloor space after being introduced into the compartment in the vehicle body from the cooling air inlet.

6. The vehicle cooling air discharge structure according to claim 3, wherein the vehicle body has a cooling air inlet formed in a front portion of the vehicle body and configured to introduce the cooling air into a compartment in the vehicle body such that the cooling air is blown into the underfloor space after being introduced into the compartment in the vehicle body from the cooling air inlet.
